(19) United States
(12) Patent Application Publication
(10) Pub. No.: US 2022/0252216 A1
(43) Pub. Date: Aug. 11, 2022

(54) Support Bracket for Fence Post or Rail

(71) Applicant: Antonio J. COSTA, Collingwood (CA)

(72) Inventor: Antonio J. COSTA, Collingwood (CA)

(21) Appl. No.: 17/666,387

(22) Filed: Feb. 7, 2022

Related U.S. Application Data
(60) Provisional application No. 63/199,985, filed on Feb. 7, 2021.

(51) Int. Cl. F16M 13/02; A47G 7/04

(52) U.S. Cl. CPC F16M 13/02; A47G 7/044

(57) ABSTRACT

A bracket for releasable attachment to a fence comprises a clamp portion, for engaging a fence component, and a support arm portion for supporting one or more types of objects. The objects may comprise hanging plants, bird feeders, lamps or lighting, etc. In one aspect, the clamp portion is adapted to engage a fence post. In another aspect, the clamp portion is adapted to engage a fence rail or a rail cap.

### CROSS REFERENCE TO PRIOR APPLICATIONS

This applications claims priority to U.S. Application No. 63/199,985, filed on Feb. 7, 2021, the entire contents of which are incorporated herein by reference.

### FIELD OF THE DESCRIPTION

The present description relates to devices used for suspending or supporting objects. In particular, the present description provides support brackets that are easily secured to fence posts or rails, wherein the brackets are adapted to suspend or support various decorative objects, such as plants, bird feeders, or shelves therefor.

### BACKGROUND

Fences are commonly found on residential and commercial properties and serve various purposes including security, safety (such as for fences along stairways), and aesthetics. Generally, fences comprise a number of fencing components, including a plurality of vertical posts between which extend two or more generally horizontal rails. In some instances, depending on the terrain, the rails may be provided at an angle that follows the slope of the ground and, therefore, may not be horizontal. The rails comprise an upper or top rail and a lower or bottom rail. Typically, a fence also includes a plurality of vertically oriented members such as pickets, spindles, fencing boards, and/or fencing panels, that are provided between the posts and which extend between the top and bottom rails. In some cases, the top rail may be provided with a decorative cap that is generally parallel with the top rail. In addition, the rails and/or the pickets may be provided with a decorative or protective caps, as is commonly known.

It is common to decorate fencing with a variety of objects such as potted or hanging plants, lights, artwork, bird feeders, and the like. It is also common to secure shelving to fences, where the shelving is used to support such objects. To achieve these purposes, support brackets or bracket systems are used, where such brackets are secured to the fence components and include means to support or suspect the object in question. Such support brackets are commonly used for wooden fences, wherein one or more brackets are attached to wooden fence components by means of screws, nails, etc. As would be understood, this results in damage to the fence components and often requires the brackets being permanently mounted since moving them would leave holes and other blemishes on the fence components. In addition, these types of known brackets cannot be easily used on metal or concrete fence components due to the difficulty in securing the brackets using common fasteners.

To address some of the above-mentioned issues, some bracket systems have been proposed allowing them to be attached to fence components without the need to permanently fasten the brackets to fence components. Some examples of such brackets and/or bracket systems are described in U.S. Pat. Nos. 10,631,672; 9,958,112; 5,118,059; GB 2,363,058; GB 2,430,609; GB 2,362,807; and GB 2,249,020. While these references generally avoid the need to permanently attach support brackets to fence components, they require either complicated clamping systems or fence components having a specific structure or configuration.

There is therefore a need for an improved support bracket or system that addresses at least one of the shortcomings mentioned above.

### SUMMARY OF THE DESCRIPTION

In one aspect, there is provided a support bracket for engaging a fence comprising: a clamp portion for releasably securing to a vertical or horizontal fence member; and, a support arm, releasably connected to the clamp portion, adapted to support an object.

In one aspect, there is provided a support bracket for engaging a fence member, the fence having at least one vertically oriented fence post and at least one horizontally aligned fence rail, the support bracket comprising:
a clamp portion adapted to releasably engage a top end of a fence post when in use;
a support arm having a first end connected to the clamp portion and a second end extending away from the clamp portion, and an elongate portion extending between the first and second ends;
the first end of the support arm including a biasing portion adapted to engage the fence post, when in use;
a brace member extending between the first end of the support arm and the elongate portion of the support arm;
the clamp portion comprising one or more flanges adapted to engage the top end of the fence post when in use.

In another aspect, there is provided a support bracket for engaging a fence member, the fence having at least one vertically oriented fence post and at least one horizontally aligned fence rail, the support bracket comprising:
a clamp portion adapted to releasably engage a top end portion of the fence rail when in use;
a support arm having a first end connected to the clamp portion and a second end extending away from the clamp portion, and an elongate portion extending between the first and second ends;
the first end of the support arm including a biasing portion adapted to engage the fence post, when in use;
a brace member extending between the first end of the support arm and the elongate portion of the support arm;
the clamp portion comprising a first section adapted to be secured to the first end of the support arm, and a second section adapted to engage an edge of the fence rail opposite to the support arm, when in use.

### BRIEF DESCRIPTION OF THE FIGURES

The features of certain embodiments will become more apparent in the following detailed description in which reference is made to the appended figures wherein:

FIG. 1 is a front perspective view of a support bracket according to one aspect of the description.

FIG. 2 is a rear perspective of the bracket shown in FIG. 1.

FIG. 3 is an exploded side perspective view of the bracket shown in FIG. 1.

FIG. 4 is a top view of the of the post engaging clamp of the bracket shown in FIG. 1.

FIG. 5 is a top perspective view of the post engaging clamp of the bracket shown in FIG. 1.

FIG. 6 is an exploded view of the post engaging clamp of the bracket shown in FIG. 1.

FIG. 7 is a rear elevation view of the post engaging clamp of the bracket shown in FIG. 1.

FIG. 8 is a right side elevation view of the post engaging clamp of the bracket shown in FIG. 1.

FIG. 9 is a left side elevation of a support arm of the bracket shown in FIG. 1.

FIG. 10 is a rear perspective view of the support arm of the bracket shown in FIG. 1.

FIG. 11 is a front perspective view of a support bracket according to another aspect of the description.

FIG. 12 is a rear perspective of the bracket shown in FIG. 11.

FIG. 13 is an exploded side perspective view of the bracket shown in FIG. 11.

FIG. 14 is a front perspective view of a support bracket according to another aspect of the description.

FIG. 15 is a rear perspective of the bracket shown in FIG. 14.

FIG. 16 is an exploded side perspective view of the bracket shown in FIG. 14.

FIG. 17 is a left side elevation of a support arm according to another aspect of the description.

FIG. 18 is a rear perspective view of the support arm shown in FIG. 17.

FIG. 19 is a left side elevation of a support arm according to another aspect of the description.

FIG. 20 is a rear perspective view of the support arm shown in FIG. 19.

FIG. 21 is a rear perspective view a support arm according to another aspect of the description.

FIG. 21a is a front perspective view of the support arm of FIG. 21 according to another aspect.

FIG. 22 is a top view of the support arm shown in FIG. 21.

FIG. 23 is a side elevation of the support arm shown in FIG. 21.

FIG. 24 is a rear perspective view a support arm according to another aspect of the description.

FIG. 25 is a top view of the support arm shown in FIG. 24.

FIG. 26 is a side elevation of the support arm shown in FIG. 24.

FIG. 27 is a front perspective view of a support bracket according to another aspect of the description.

FIG. 28 is a rear perspective of the bracket shown in FIG. 27.

FIG. 29 is an exploded side perspective view of the bracket shown in FIG. 27.

FIG. 30 is a side view of the bracket shown in FIG. 27.

### DETAILED DESCRIPTION

As used herein, the terms “bracket” or “bracket system” will be understood to mean an apparatus or device that serves to support an object, such as discussed above. In the context of the present description, the terms “bracket” or “bracket system” will be understood to mean a support apparatus or device that is designed to be connected to a fence component, preferably in a releasable manner. Such fence component may be a post, a spindle, a top rail, and/or a top rail cap.

As used herein, the terms “top”, “upper”, “bottom”, and “lower” will be used to characterize or distinguish certain components from others. It will be understood that these terms are used in reference to the respective components when in use either as part of or in association with a fence.

The terms “comprise”, “comprises”, “comprised” or “comprising” may be used in the present description. As used herein (including the specification and/or the claims), these terms are to be interpreted as open-ended terms and as specifying the presence of the stated features, integers, steps or components, but not as precluding the presence of one or more other feature, integer, step, component or a group thereof as would be apparent to persons having ordinary skill in the relevant art. Thus, the term “comprising” as used in this specification means “consisting at least in part of”. When interpreting statements in this specification that include that term, the features, prefaced by that term in each statement, all need to be present but other features can also be present. Related terms such as “comprise” and “comprised” are to be interpreted in the same manner.

The phrase “consisting essentially of” or “consists essentially of” will be understood as generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open-ended term, such as “comprising” or “including”, it will be understood that direct support should be afforded also to “consisting essentially of” language as well as “consisting of” language as if stated explicitly and vice versa. In essence, use of one of these terms in the specification provides support for all of the others.

The term “and/or” can mean “and” or “or”.

Unless stated otherwise herein, the articles “a” and “the”, when used to identify an element, are not intended to constitute a limitation of just one and will, instead, be understood to mean “at least one” or “one or more”.

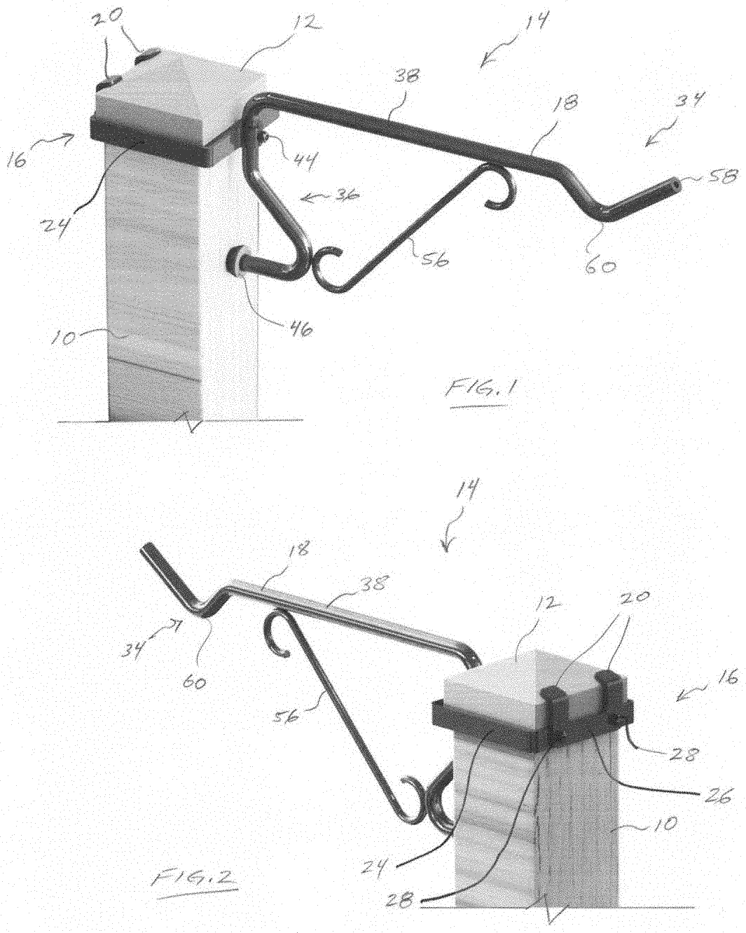

FIG. 1 illustrates a bracket of the present description according to one aspect. In this aspect, the bracket is adapted to be provided on a fence post 10. In one aspect, the fence post 10 may optionally include a post cap 12, as known in the art. The bracket, generally indicated at 14, comprises a clamp, or clamp portion, 16, that is adapted to engage a fence post such as shown at 10, and a support arm 18 that connects to the clamp 16. In one aspect, as shown in FIG. 3 for example, the clamp 16 and support arm 18 are provided as two sections that are adapted to be connected together. As discussed further below, this arrangement is preferred in order to facilitate installation of the bracket 14 on a fence and to allow different versions of the clamp and support arm to be substituted.

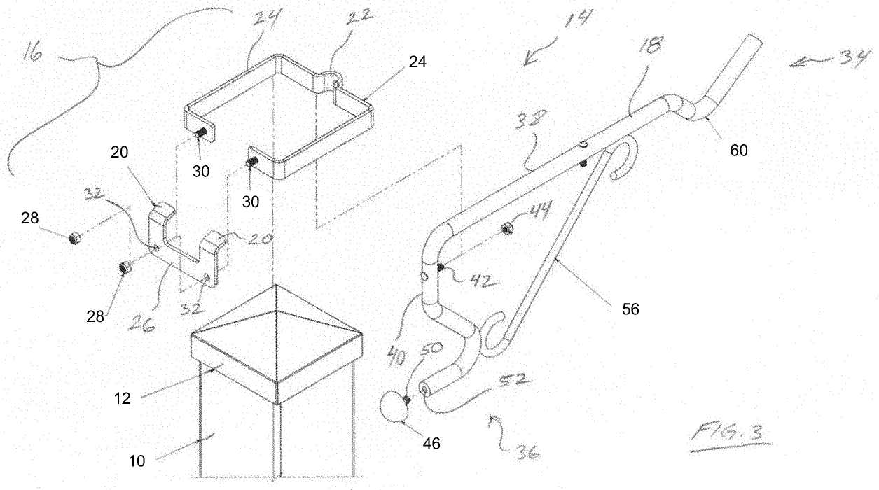

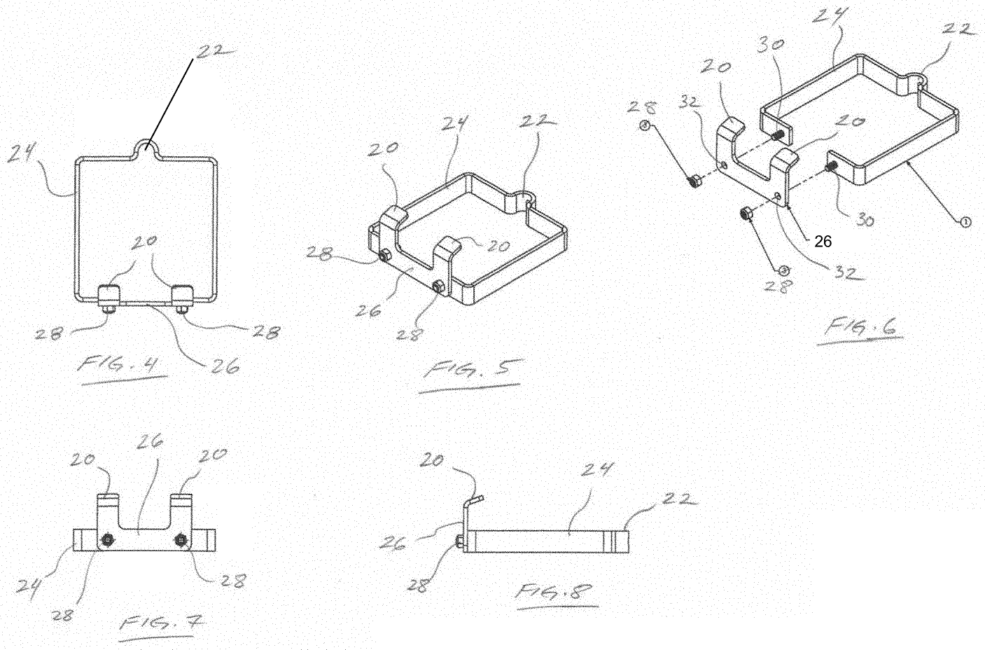

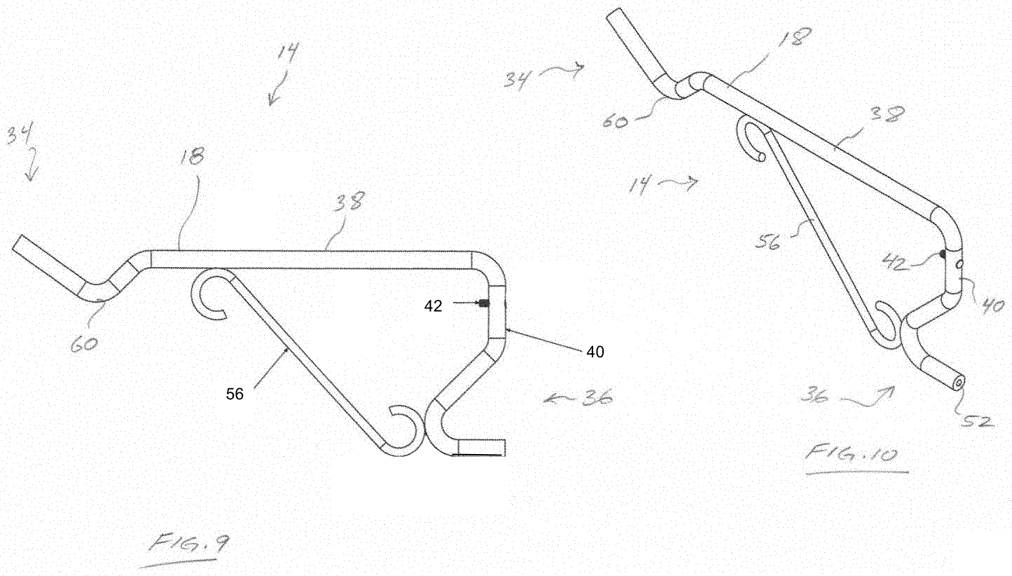

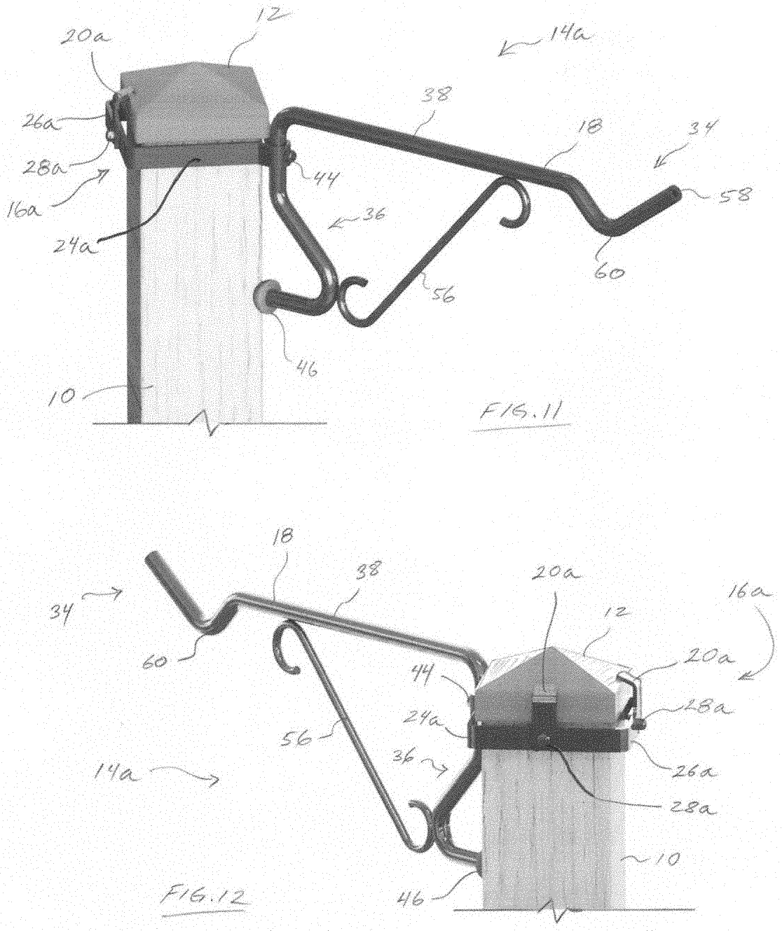

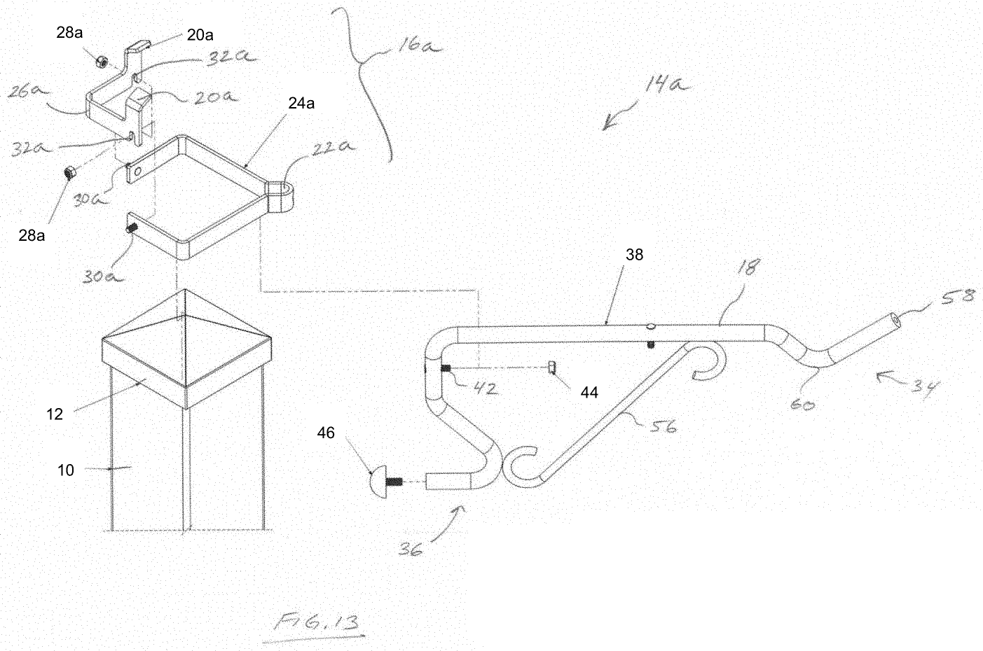

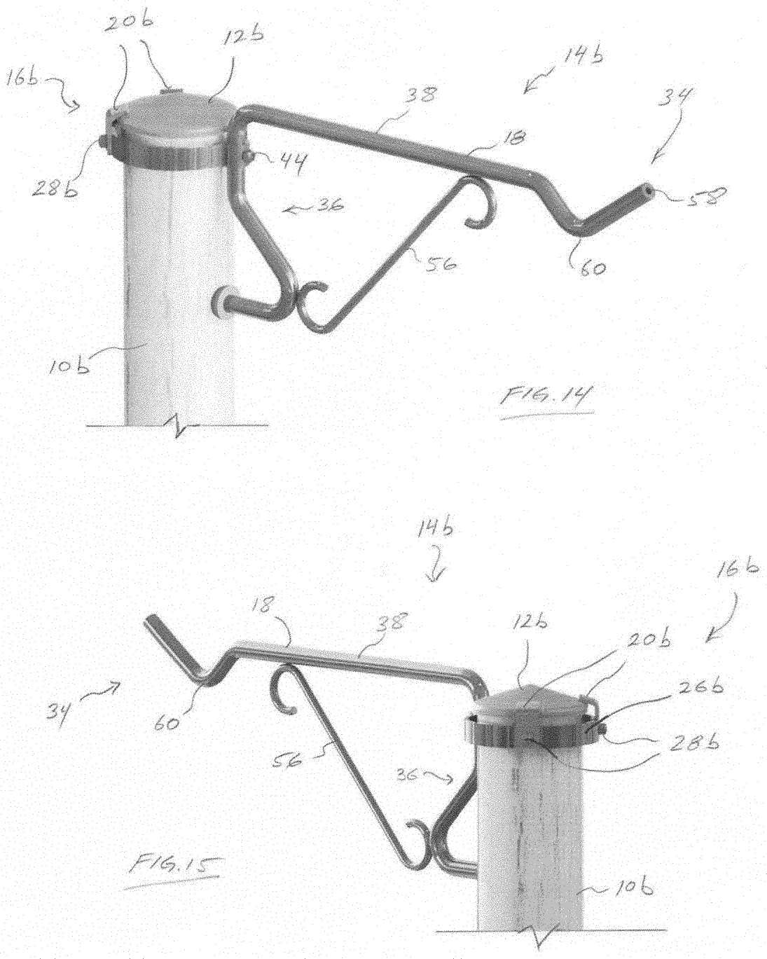

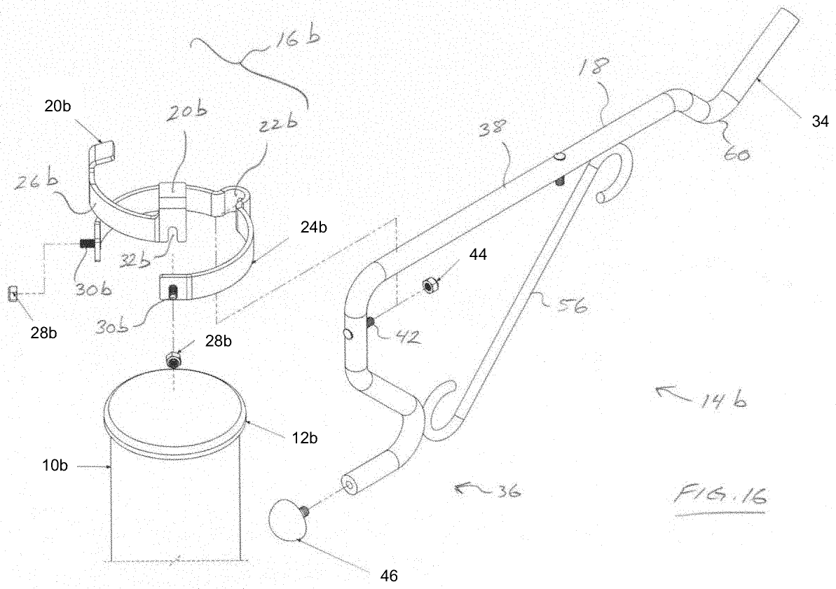

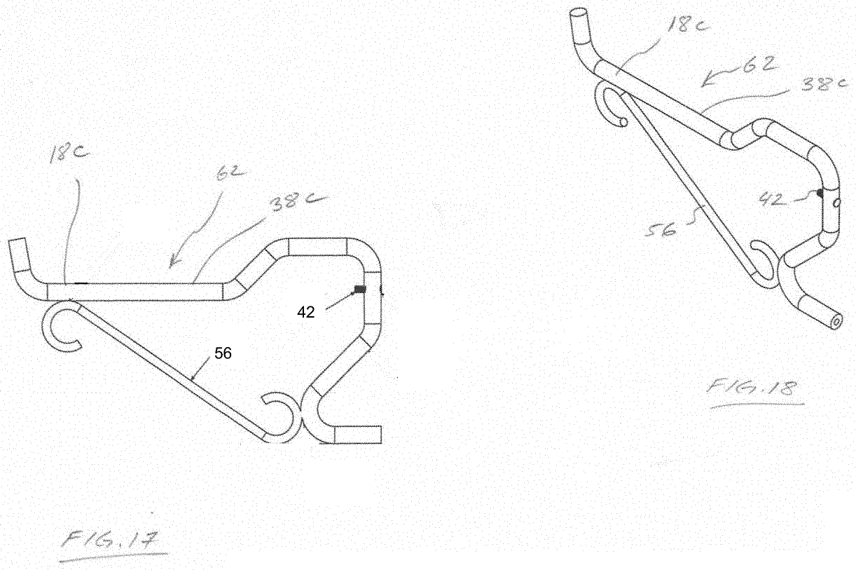

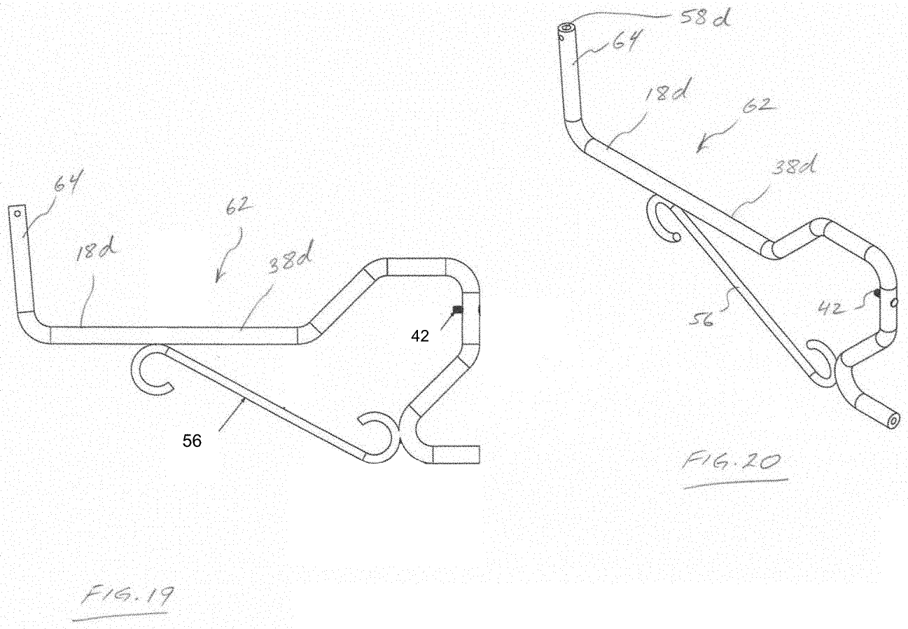

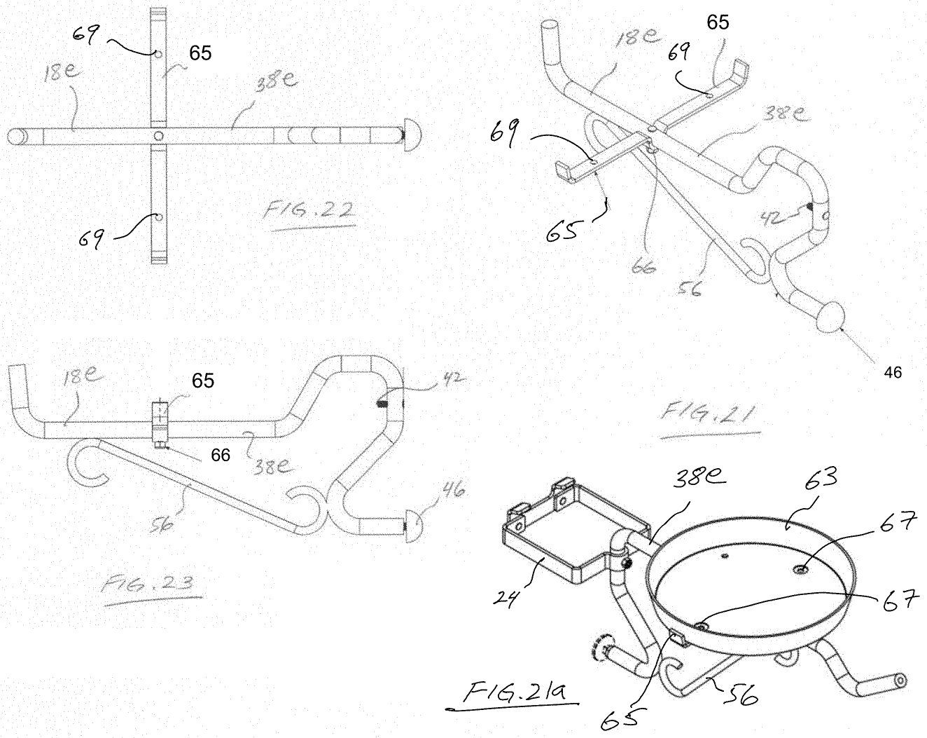

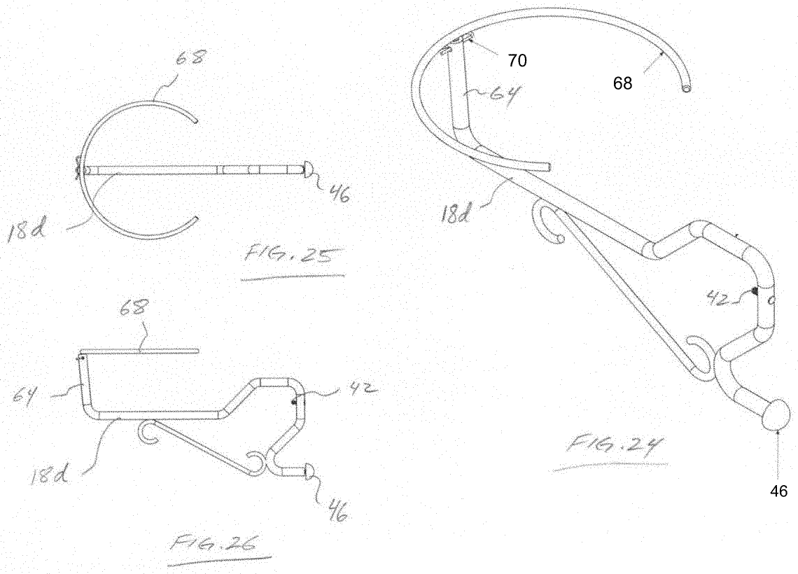

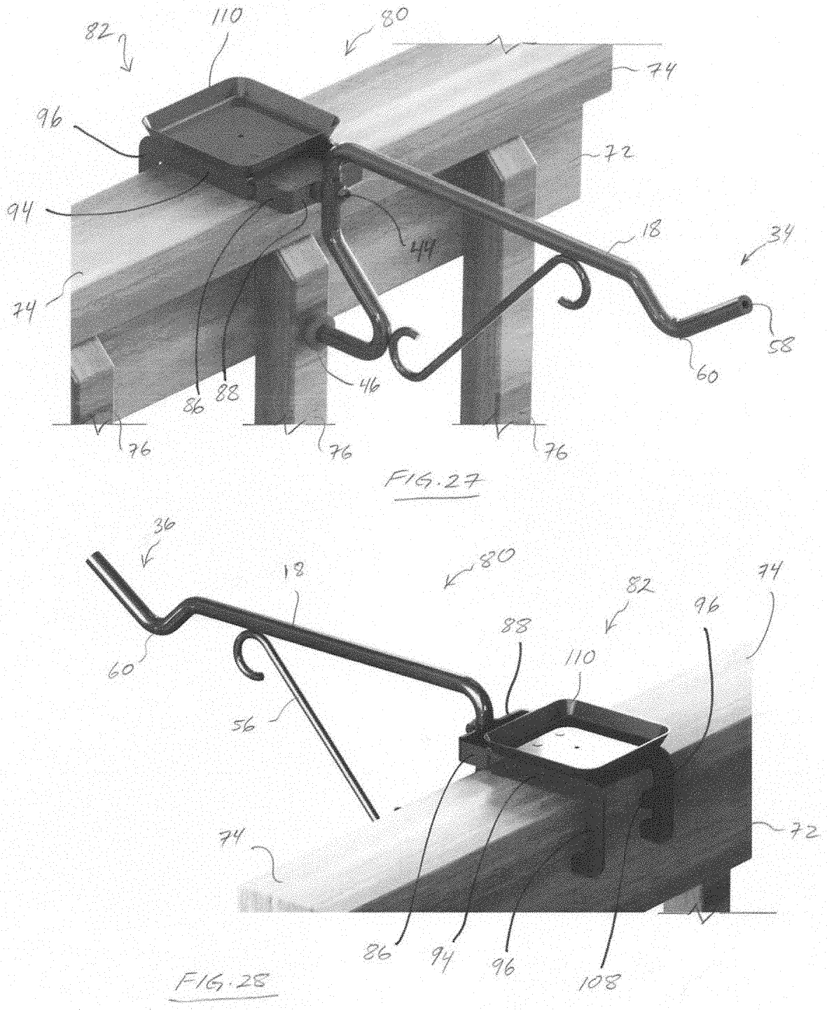

As shown in FIGS. 1-3, the clamp 16 comprises a generally ring-shaped structure defining an opening that is adapted to encompass the perimeter of the fence post 10. For this reason, the clamp 16 is provided with a shape that generally conforms to the shape of the post 10 to which the bracket 14 is to be connected. For example, in the version shown in FIGS. 1-8, the clamp 16 has a generally square configuration to accommodate a square fence post 10. As described further below, the clamp may be shaped to accommodate any shape of fence post. Further, as known in the art, fence post dimensions may vary from one installation to another and, accordingly, the size of the clamp 16 may be similarly varied. As shown in FIGS. 1-3, the clamp 16 is preferably adapted to fit over the fence post 10 and, more specifically, proximal to the top end of the post. Thus, it will be appreciated that the clamp 16 will be sized to have an opening that is larger than the perimeter of the fence post 10. In one aspect the clamp 16 may be designed to accommodate a range of fence post sizes.

The clamp 16 is provided with a number (i.e. one or more) tabs 20, preferably at a rear end thereof. It will be appreciated that any number of tabs 20 may be provided on the clamp 16 and may be provided in different areas thereof. The tabs 20 are provided to engage, or bear or rest against, the top end of the fence post 10 when the clamp is installed. As noted above, in some cases, the fence post 10 may be provided with a post cap 12, in which case the tabs, as shown in FIGS. 1-3, would engage the top end of the cap 12. As will be appreciated, the tabs 20 are provided to limit or set the vertical position of the clamp 16 on the post 10.

The clamp 16 includes a front end, opposite the rear end, where the front end is provided with an engagement means to engage or connect with the support arm 18. In one preferred aspect, the support arm engagement means comprises a groove 22 provided in the ring structure of the clamp 16, wherein the groove 22 is adapted to received a portion of the support arm 18. In one aspect, the groove 22 has a generally curved or semi-circular shape, as shown in the accompanying figures, in order to accommodate a generally tubular structure of the support arm 18. It will be understood that the shape of the groove 22 may vary depending on the shape of the support arm 18, or the portion thereof, that is engaged by the clamp 16. For example, in one aspect, the support arm 18, or the portion engaged by the clamp 16, may have a square, rectangular, or a flattened shape, in which case the groove 22 would be provided with a complementary shape to engage same.

In the aspects illustrated in the accompanying figures, the groove 22 is directed outwardly, wherein the groove 22 opens to the interior of the clamp 16. In this arrangement, a portion of the support arm 18 is received within the ring structure of the clamp 16. Accordingly, with such arrangement, when the bracket 14 is in use, the portion of the support arm 18 engaged in the recess 22 is retained between the clamp 16 and the fence post 10, as illustrated in FIGS. 1-3. While this arrangement is preferred, it will be appreciated that the groove 22 may, in another aspect, be provided in an opposite orientation, wherein the groove opens away from the interior of the clamp 16. In such arrangement, the support arm 16 would not be received within the ring structure of the clamp 16, but may still be sufficiently connected thereto. In one example, with such an arrangement, a flange or the like may be used to secure the support arm 18 to the clamp 16. In this variation, the interior surface of the clamp 16 may be provided with spacers or the like that adapt the clamp to engage the surfaces of the fence post 10.

In another aspect, the support arm 18 may be provided with a hook or like means that is designed to be received within the recess 22. It will be appreciated that this would form another means of engaging the support arm 18 to the clamp 16.

In one aspect, the clamp 16 is preferably formed in two sections, namely, a first section 24, comprising an open ring structure including the groove 22, and a second section 26. In one aspect, as illustrated in the figures, the second section 26 is provided with the tabs 20 mentioned above, although, as mentioned above, tabs 20 may also be provided on the first section 24, or on both sections 24 and 26. The first and second sections, 24, 26, are preferably joined together by means of fasteners, such as screws, nuts and bolts, or the like, as illustrated in FIGS. 3-8. In one aspect, the fasteners comprise nuts 28 that engage bolts 30 that are affixed to the first section 24 and which extend through apertures 32 on the second section 26. In another aspect, the apertures 32 may comprise slots, as discussed below. The description is not limited to any particular means for joining the sections 24 and 26 together.

As will be understood by persons skilled in the art, providing the clamp 16 in sections provides a few advantages. For example, and as discussed further below, the open ring structure of the first section 24 allows the clamp 16 to be first connected to the support arm and then mounted on a fence post 10. This is advantages in cases as illustrated herein where the portion of the support arm 18 engaged by the ring cannot be accessed for receipt within the recess 22. Further, by providing the first section 24 with an open ring structure, it can be slightly opened to fit over a post cap 12, where such cap has a perimeter that is larger than that of the post 10, or to otherwise facilitate the installation of the clamp 16 on a fence post 10.

In other aspects, the clamp 16 may be optionally provided with one or more centering or positioning means, such as bolts or the like, to be urged against the post 10 and thereby allow the clamp to be anchored to the post or accommodated over a smaller dimension post.

One aspect of a support arm 18 of the description is illustrated in FIGS. 3, 9 and 10. As shown, the support arm 18 comprises a front end 34 and a rear end 36, between which extends a generally linear section 38. The rear end 36 of the support arm 18 is adapted (as discussed below) to engage the clamp 16 and to bear against the fence post 10, when in use. The linear section 38 is, in one aspect, adapted to extended generally perpendicularly to the fence post 10 when the bracket 14 is in use. In a preferred aspect, the rear end 36 of the support arm 18 extends generally perpendicularly from the linear section 38 thereby providing the support arm 18 with a generally “L” shaped structure, as illustrated.

The rear end 36 of the support arm 18 comprises a clamp engagement section 40, which is adapted to be received within the recess 22 of the clamp 16 and secured thereto. The support arm 18 and clamp 16 may be connected using various types of fasteners etc. For example, in one preferred aspect as illustrated, the clamp engagement section 40 includes a bolt 42 affixed thereto, which is adapted to extend through an aperture (not shown) in the recess 22 of the clamp 16. More specifically, in order to secure the support arm 18 to the clamp, the clamp engagement section 40 of the support arm 18 is inserted through the first, open ring, section 24 of the clamp 16 and is aligned with the recess 22. In this way, the bolt 42 is inserted through the aperture provided in the recess 22 so as to extend there-through. Following this, a nut 44, such as shown in FIG. 3, is then used to secure the support arm 18 to the clamp 16.

In a preferred aspect, the bracket 14 further optionally includes an adjustment bumper 46 to adjust the alignment of the support arm 18. More particularly, in the aspect illustrated, the bumper 46 comprises a bearing end 48 adapted to bear against a fence post 10, when the bracket 14 is in use. The bumper 46 further comprises a threaded bolt 50 that is adapted to be received within a correspondingly threaded aperture 52 provided at the rear end 36 of the support arm 18. As will be understood, when the bracket is in use, the adjustment bumper 46 can be rotated so as to adjust the horizontal angle of the linear section 38 of the support arm 18.

In another preferred aspect, the support arm 18 of the bracket 14 may be provided with a brace 56 extending from the rear end 36 of the support arm 18 towards the front end 34 thereof. In one aspect, the brace 56 connects to a portion of the linear section 38 as illustrated. In a preferred aspect, the brace 56 is permanently attached to the portions of the support arm 18, such as by welding etc. As will be understood, the brace 56 serves to provide vertical support to the linear section 38, when the support arm bears a load (as discussed further below). While the inclusion of the brace 56 is preferred in order to provide support and stability to the support arm 18, it will be understood that in some aspects, it may be omitted, such as in cases where the support arm 18 is manufactured from materials having a sufficient tensile strength.

When installing the bracket 14 on a fence post 10, the following steps may be performed. Preferably, the clamp 16 and support arm 18 would be connected together as described above. That is, the clamp engagement section 40 of the support arm 18 is inserted through the first, open ring section 24 of the clamp 16 and is aligned with the recess 22. In doing so, the bolt 42 is inserted through the aperture provided in the recess 22. The nut 44 is then tightened onto the bolt 42, thereby securing the first section 24 of the clamp 16 and the support arm 18 together. Following this, the first section 24 of the clamp 16, with the support arm 18 attached, is connected to the second section 26 of the clamp by aligning the first and second sections, 24 and 26, together in order to have the bolts 30 inserted into the respective apertures 32 provided on the second section 26. The second section 26 of the clamp 16 is then secured to the first section 24 by tightening the nuts 28 onto the bolts 30. The assembled bracket 14 is then slid over the top of a fence post 10, and over the post cap 12 if present. As will be understood, and as discussed above, the vertical alignment of the bracket 14 is limited when the tabs 20 abut the top of the post 10 or, if present, the cap 12. Following this, and if needed, the horizontal alignment of the support arm 18 may be adjusted by rotating the bumper 46 and adjusting its position against the post 10. It will be understood that the first and second sections, 24 and 26, of the clamp 16 may be connected together after aligning such sections with a fence post. This may be needed in situations where the dimensions of the cap 12 are greater than the internal dimensions of the clamp 16.

As will be understood, with the clamp 16 described above, the bracket 14 can be easily installed on a fence post and removed therefrom without the use of any fasteners etc. being required to engage the fence post itself. This therefore avoids damage to the fence post and allows the bracket 14 to be installed and removed without any tools or added effort. The tabs 20 serve to ensure that the bracket 14 is maintained at a desired vertical position on the fence post.

FIG. 1 illustrates an option where the support arm 18 may be provided with an aperture 58 at the terminal end of the front end 34 thereof. Such aperture may be threaded or unthreaded and may be adapted to receive any further element, such as a decorative flag, a hook, etc. The presence of the aperture 58 is optional and the description is not limited to the presence or absence of such feature.

FIGS. 1-3 further illustrate an optional bend or hook 60 provided on the support arm 18 at a location proximal to the front end 34. As would be apparent to persons skilled in the art, the hook 60 is adapted to receive a hook of a hanger, such as a hanger for a potted plant, a bird feeder, a lamp, or any other hanging device. The presence of a hook 60 is preferred as it expands the use of support arm 18 to a user's needs. The hook 60 may also be provided at other locations along the length of the support arm and more than one such hooks may be provided.

As will be understood, two or more of the support arms 18 may be provided on adjacent fence posts whereby the linear portions 38 of the support arms combine to form a support structure for a plank or the like. In this way, a shelf may be provided on a fence. Further variations of the support arm 18 are described below. It will be understood that the present description is not limited in any way to how the support arms may be used.

One feature that will be apparent to persons skilled in the art is that, by providing the clamp 14 and support arm 18 as separate components, the same clamp 14 may be used with different or modified support arms 18.

FIGS. 11-13 illustrate another aspect of the description, wherein elements that are the same or similar to those described above are identified with like reference numerals. In some cases the letter “a” is used to differentiate those elements that are similar but not identical to those previously described.

As discussed above, FIGS. 1-3 illustrate a bracket 14 that is adapted to extend away from one of the faces of a generally square fence post 10. FIGS. 11-13, on the other hand, illustrate an aspect of the description wherein the bracket 14a is also adapted to be provided on a generally square post 10, but at an angle with respect to the faces thereof. In particular, as illustrated in FIGS. 11-13, the bracket 14a is adapted to extend from one of the corners of the fence post 10. As would be understood, this aspect of the description would be advantageous for use on fence posts that are provide on the corners of a fence.

With the aspect illustrated in FIGS. 11-13, the support arm 18 is generally the same as that described above. However, the clamp, identified at 16a, is modified for use in a corner arrangement on a fence post 10. As illustrated, the clamp 16a is again preferably provided in two sections, namely a first section 24a and a second section 26a. As shown in FIG. 13, the second section 26a is adapted to be connected to the first section 24a by means of apertures 32a provided thereon, which are adapted to receive bolts 30a extending from the first section 24a. The sections 24a and 26a are secured together by means of nuts 28a. As shown more clearly in FIG. 13, the apertures 28a of the second section 26a comprise slots instead of holes. Such an option was discussed above in relation to the description of FIGS. 1-10. It will be understood that either slots or holes may be used as the apertures in all aspects described herein. As discussed above, any number of fastening means may be used to connect the sections 24a and 26a together. Similarly, in other aspects, the clamp 16a may comprise a unitary structure.

As illustrated in FIGS. 11-13, the clamp 16a differs from the clamp 16 discussed above in that the recess 22a is provided at a corner of the first section 24a of the clamp 16a. Consequently, the second section 26a is preferably provided as an angled component (as shown in FIG. 13), that, when in use, is adapted to be adjacent a corner of fence post 10 opposite to the recess 22a.

In installing the bracket 14a, the same procedure as above may be followed.

As shown in FIGS. 11-13, an adjustment bumper 46 is provided with the bracket 14a, which serves the same purpose as discussed above. However, it will be understood that the bumper provided in the aspect of FIGS. 11-13 may be optionally adapted to receive a corner of the fence post 10 instead of being adapted to bear against a flat surface. For example, the bumper 46 may be provided with a notch or similar groove etc. (not shown) to positively engage a corner of the post 10. Since the bumpers are threadingly attached to the support arm 18, they may be replaced with any bumpers that are specifically modified for a particular purpose, such as engaging a corner etc.

As mentioned above, the support arm 18 shown in FIGS. 11-13 may be the same as that discussed above in relation to FIGS. 1-10. In this regard, the support arm 18 of FIGS. 11-13 may also include an aperture 58 and/or a hook 60 as described above. However, as discussed further below each of the brackets described herein may be formed with any version of a support arm, some of which are described herein.

FIGS. 14-16 illustrate another aspect of the description, wherein elements that are the same or similar to those described above are identified with like reference numerals. In some cases the letter “b” is used to differentiate those elements that are similar but not identical to those previously described.

As will be understood, the aspect of the description illustrated in FIGS. 14-16 is adapted for use on circular fence posts, such as shown at 10b. The posts may also be provided with correspondingly shaped post caps 12b.

In use, the bracket 14b of FIGS. 14-16 is similar to that described above. However, the clamp 16b is provided with a generally circular configuration that is adapted to engage the circumference of a round fence post 10b. Due to the round configuration of the fence post, it will be understood that the bracket 14b may be used with posts 10b that are positioned either at corners or along the sides of a fence.

The bumper 46 shown in FIGS. 14-16 may be the same as the bumper described above. However, in other aspects, the bumper may be replaced with one having a curved surface to positively engage the curved outer circumference of the fence post 10b and thereby add further stability.

As discussed above, the support arm of the bracket may have a variety of configurations and/or features. FIGS. 17-20 illustrate two alternative versions of the support arms that can be used according to the present description. As shown in FIGS. 17-18, a first alternative variation, identified as 18c, includes a depression 62 along the length of the linear portion 38c. In FIGS. 19-20, the support arm 18d includes a similar depression 62 as well as an extension 64 at the terminal end of the front end thereof.

FIGS. 21-23 illustrate a variation of the support arm, identified as 18e, wherein the support arm is similar to the support arm 18c but further comprises a cross member 65 that extends generally perpendicularly to the linear portion 38e of the support arm 18e. The cross member 65 may be releasably connected to the support arm. In the example illustrated, the linear portion 38e includes a bolt that is received within an aperture provided in the cross member 65. A nut 66 is then used to secure the cross member 65 to the support arm 18e. Preferably, and as illustrated in FIGS. 21 and 23, the cross member 65 includes a recess to receive a portion of the support arm 18e. As will be appreciated, the version of the support arm 18e shown in FIGS. 21-23 is adapted to support an object resting thereon, such as a pot for a plant or other such object. In particular, the upper portion of the support arm 18e and the cross member 65 form a platform on which an object can rest. In this regard, FIG. 21a illustrates an aspect where such a platform, or tray, 63 is provided. In order to secure the tray 63 to the support bracket, clips, anchors, or other such securing means, such as shown at 67, may be provided through apertures in the tray 63. The securing means 67 are adapted to engage openings 69 provided in the cross member 65, as shown in FIGS. 21 and 22.

FIGS. 24-26 illustrate another variation of the support arm that is adapted to support an object, such as a pot etc. In this example, the support arm is similar to the support arm 18d illustrated in FIGS. 19-20, but includes a further attachment 68 comprising a ring to encompass the circumference or perimeter of the object. The attachment 68 includes a spindle (not shown) that is inserted into an aperture 58d as shown in FIG. 20. A retaining means, such as a retaining pin 70 or the like, may also be provided to retain the attachment 68 on the support arm 18d.

As mentioned above, and as will be understood by persons skilled in the art, any of the support arms described herein can be used with any of the clamps. In other words, the clamps and support arms described herein are adapted to be interchangeable.

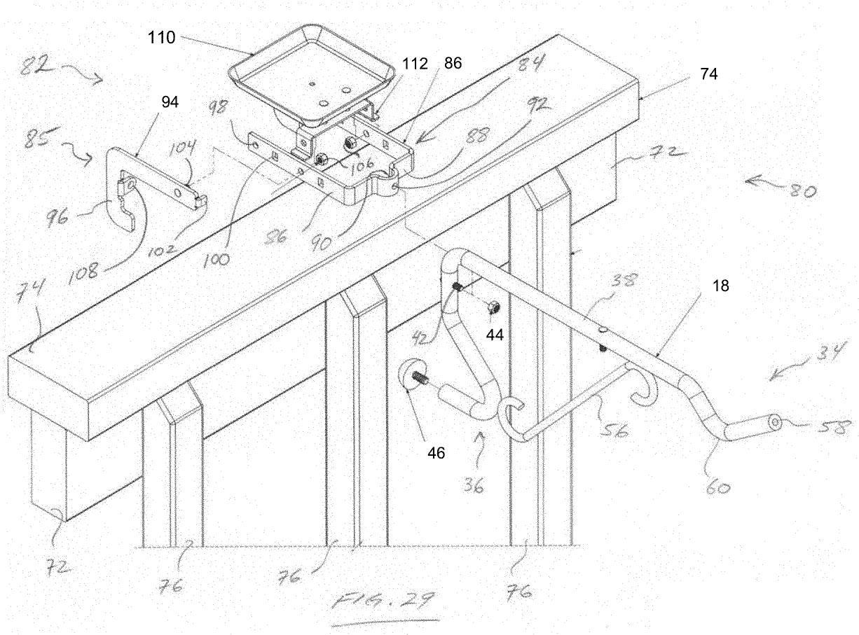

In the foregoing description, a bracket for attachment to a fence post has been described. FIGS. 27-30 illustrate a further aspect wherein a bracket is provided for securing to a top rail cap of a fence. In FIGS. 27-30 a portion of a fence is illustrated with a top rail 72, a rail cap 74, and several pickets 76. It will be understood that the illustrated portion of the fence may extend between posts as discussed above. In FIGS. 27-30, the bracket is described for engagement to a rail cap such as shown at 74; however, as will be understood, the bracket may equally be adapted for engagement directly to a top rail 72 where no rail cap is provided.

As described further below, the bracket for use on fence rails or rail caps involves a variation in the clamp portion; however, such clamp may still be used with any of the support arms described above. In FIGS. 27-30, therefore, a support arm 18 is illustrated, which is similar to the support arm illustrated in FIGS. 1-3. Accordingly, like reference numerals will be used to identify like elements of the support arm. It will be understood that the aspect shown in FIGS. 27-30 is not limited to the support arm illustrated.

As mentioned above, FIGS. 27-30 illustrate a bracket 80 that is adapted for engaging or being connected to a rail cap 74 of a fence. The bracket includes a clamp 82 that comprises a first section 84 having a generally “U” shaped structure with a pair of arms 86 connected by a transverse member 88. The arms 86 are provided to lie over the rail cap 74 when the bracket 80 is in use. The transverse member 88 includes a recess 90 to accommodate a portion of the support arm 18, in the manner described above. In a similar manner, the support arm 18 is secured to the transverse member 88 by extending the bolt 42 through an aperture 92 provided in the recess 90. A nut 44 is then provided to secure the support arm 18 to the first section 84 of the clamp 80.

A second section 85 of the clamp 80 comprises two generally “C” shaped elements each comprising an arm 94, adapted to engage a respective arm 86 of the first section 84. Each arm 94 further includes a hook portion 96 adapted to engage an end of the rail cap 74 when the clamp 80 is in use. As shown in FIGS. 27-30, in a preferred aspect, the hook portions 96 are sized to wrap around an end of the rail cap 74. It will therefore be understood that the hook portions 96 are sized to accommodate typical thicknesses of rail caps 74. For example, a typical rail cap 74 may be formed of a 2×4 inch or 2×6 inch member, which would generally have a 1.5 inch thickness.

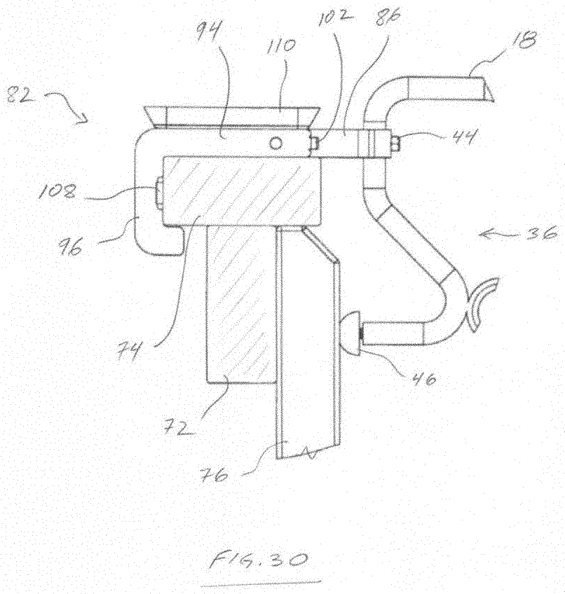

As shown more clearly in FIG. 29, the arms 86 of the first section 84 are provided with a number of apertures 98 and notches 100, which serve to engage respective arms 94 of the second section 85 of the clamp 80. More particularly, the notches 100 on the arms 86 are adapted to receive locating tabs 102 provided at the ends of the arms 94 of the clamp second section 85. As will be understood, the engagement of the tabs 102 in respective notches 100 serves to locate and align the respective arms 86 and 94 together. The apertures 98 of the arms 86 are adapted to receive bolts 104 provided on the arms 94. Nuts 106 are then used to secure the arms 86 and 94 together. As illustrated in FIG. 29, each of the arms 86 are preferably provided with a plurality of apertures 98 and notches 100. In this way, the respective position of the arms 94 on the arms 86 can be adjusted to accommodate different widths of the rail top cap 74. For example, as noted above, the top cap 74 may comprise a 2×4 or 2×6 member, which would have a width of 3.5 inches or 4.5 inches, respectively. The apertures 978 and notches 100 would therefore preferably be provided in two sets to accommodate such member sizes, as illustrated in FIG. 29.

As shown in FIGS. 28 and 29, the hook portions 96 of the second section 85 of the clamp 80 preferably include stops 108, which serve to brace the hook portions 96 against the end of the rail cap 74 when the clamp 80 is in use. The stops 108 may also be used to secure the clamp to the rail cap 74 by means of fasteners etc., if needed.

In use, the first section 84 of the clamp 80 is first connected to the support arm 18 by securing the rear end 36 of the support arm 18 by inserting the nut 42 of the support arm 18 through the aperture 92 provided in the recess 90 and tightening the nut 44 thereover. As will be appreciated, this is similar to the step discussed above in respect of the previous aspect of the description. Thereafter, the arms 86 of the first section 84 are aligned with and secured to the arms 94 of the second section 85, as described above. The assembly comprising the clamp sections 84 and 85 and the support arm 18 is then installed over a rail cap 74 as shown in FIGS. 27-30. The bumper 46 may then be adjusted to position the support arm 18 in a desired orientation. Thereafter, the support arm 18 can be used in the same manner as described above.

In a preferred aspect, the clamp 80 may also be provided with a platform 110, which may also be used to support objects and the like. As illustrated, the platform 110 preferably extends between and over the arms 86 and 94 of the first and second sections of the clamp 80. It will be appreciated that the platform 110 may be connected to the clamp 80 in any suitable manner. For this purpose, the clamp 80 may, in one aspect, be provided with a support stage 112 that extends across the respective arm pairs 86 and 94 and which is adapted to be secured to the arms. In one aspect, as illustrated in FIG. 29, the support stage 112 includes apertures at opposed ends that are adapted to cooperate with the bolts 104 extending from the arms 94 of the second section 85. In this way, once the nuts 106 are secured to connect the respective arms 94 and 86 together, the stage 112 is also correspondingly connected to the assembly. The platform 110 may then be connected to the stage 112 using fasteners etc. In one example, the platform 110 may have bolts connected thereto, which are adapted to be inserted into apertures provided on the stage 112. Thereafter, nuts may be used to engage such bolts and thereby connect the platform 110 to the stage 112.

The above description of FIGS. 27-30 has related to a clamp 80 that is adapted to engage a rail cap 74. However, as will be understood, the clamp 80 may be modified to engage a fence top rail 72 where no cap is provided. In such case, it would be understood that the second section 85 of the clamp 80 would be provided with a hook 96 that is extended to accommodate the width of the rail 72 as shown in the figures. Similarly, the lengths of the arms 86 and 94 would be shortened to rest on the top end of the rail 72.

Although the above description includes reference to certain specific embodiments, various modifications thereof will be apparent to those skilled in the art. Any examples provided herein are included solely for the purpose of illustration and are not intended to be limiting in any way. Any drawings provided herein are solely for the purpose of illustrating various aspects of the description and are not intended to be drawn to scale or to be limiting in any way. The scope of the claims appended hereto should not be limited by the preferred embodiments set forth in the above description, but should be given the broadest interpretation consistent with the present specification as a whole. The disclosures of all prior art recited herein are incorporated herein by reference in their entirety.

We claim:

1. A support bracket for engaging a fence member, the fence having at least one vertically oriented fence post and at least one horizontally aligned fence rail, the support bracket comprising:
a clamp portion adapted to releasably engage a top end of a fence post when in use;
a support arm having a first end connected to the clamp portion and a second end extending away from the clamp portion, and an elongate portion extending between the first and second ends;
the first end of the support arm including a biasing portion adapted to engage the fence post, when in use;
a brace member extending between the first end of the support arm and the elongate portion of the support arm;
the clamp portion comprising one or more flanges adapted to engage the top end of the fence post when in use.

2. The support bracket of claim 1, wherein the clamp portion includes one or more flanges adapted to engage a top surface of the top end of a fence post when the support bracket is in use.

3. The support bracket of claim 2, wherein the one or more flanges are releasably attached to the clamp portion.

4. The support bracket of claim 2, wherein the clamp portion is releasably attached to the first end of the support bracket.

5. The support bracket of claim 2, wherein the clamp portion is provided with a profile corresponding to a contour of the fence post.

6. The support bracket of claim 5, wherein the clamp portion is provided with a round or square profile.

7. The support bracket of claim 2, wherein at least one of the elongate portion and the second end of the support arm is adapted to support an object.

8. The support bracket of claim 2, wherein the second end of the support arm includes hook.

9. The support bracket of claim 2, wherein the elongate portion includes a cross member.

10. The support bracket of claim 9, further comprising a support plate attached to the cross member.

11. A support bracket for engaging a fence member, the fence having at least one vertically oriented fence post and at least one horizontally aligned fence rail, the support bracket comprising:
a clamp portion adapted to releasably engage a top end portion of the fence rail when in use;
a support arm having a first end connected to the clamp portion and a second end extending away from the clamp portion, and an elongate portion extending between the first and second ends;
the first end of the support arm including a biasing portion adapted to engage the fence post, when in use;
a brace member extending between the first end of the support arm and the elongate portion of the support arm;
the clamp portion comprising a first section adapted to be secured to the first end of the support arm, and a second section adapted to engage an edge of the fence rail opposite to the support arm, when in use.

12. The support bracket of claim 11, wherein the first section of the clamp portion comprises:
a generally U-shaped member having arms extending away from the support arm,
each arm of the U-shaped member having a generally C-shaped section adapted to receive an edge of the fence rail.

13. The support bracket of claim 12, wherein the C-shaped sections are releasably attached to the arms of the U-shaped member.

14. The support bracket of claim 13, wherein the position of the C-shaped sections are adjustable with respect to the U-shaped member.

15. The support bracket of claim 11, wherein the clamp portion is releasably attached to the first end of the support bracket.

16. The support bracket of claim 11, wherein the clamp portion is provided with a support platform.

17. The support bracket of claim 11, wherein at least one of the elongate portion and the second end of the support arm is adapted to support an object.

18. The support bracket of claim 11, wherein the second end of the support arm includes hook.

19. The support bracket of claim 11, wherein the elongate portion includes a cross member.

20. The support bracket of claim 19, further comprising a support plate attached to the cross member.
